(19) United States
(12) Patent Application Publication
(10) Pub. No.: US 2005/0176481 A1
(43) Pub. Date: Aug. 11, 2005

(54) Antenna device for portable wireless terminal

(75) Inventor: Seong-Heon Jeong, Gunpo-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/969,589

(22) Filed: Oct. 20, 2004

(30) Foreign Application Priority Data
Feb. 6, 2004 (KR) 7893/2004

(51) Int. Cl. H04M 1/00

(52) U.S. Cl. 455/575.7; 455/575.1

(57) ABSTRACT

Disclosed herein is an antenna device for use with a portable wireless terminal. The antenna device includes a pair of chip antennas mounted on a main board of the terminal and adapted to transmit and receive high-frequency signals of different frequency bands, respectively, at least one pair of radiation plates electrically connected with the respective chip antennas, and a high-frequency signal line for electrically connecting the chip antennas with a circuit portion of the main board. With the antenna device of the portable wireless terminal configured according to the present invention, it is possible to mount the antenna device inside the terminal and to improve assembly productivity by allowing the antenna device to be simply mounted on a main board using a surface mounting device, as well as facilitate operation in different frequency bands.

### PRIORITY

This application claims priority to an application entitled “ANTENNA DEVICE FOR PORTABLE WIRELESS TERMINAL”, filed in the Korean Intellectual Property Office on Feb. 6, 2004 and assigned Serial No. 2004-0007893, the contents of which are hereby incorporated by reference.

### BACKGROUND OF THE INVENTION

1. Field of the Invention

The present invention relates to portable wireless terminals, and more particularly to an internal antenna device for use with a portable wireless terminal operating in dual bands.

2. Description of the Related Art

Generally, “portable wireless terminals” are mobile communication devices that connect a partner or service provider with a user through a base station, and enable voice communication, data transmission, etc.

Such portable wireless terminals are classified into bar-type, flip-type, and folder-type terminals on the basis of their form. In recent years other wireless terminals have appeared, for example, sliding-type or swing-type wireless terminals designed to be opened or closed as a pair of housings thereof longitudinally slide or rotate, respectively, relative to each other to close with or open from each other. As the use of portable wireless terminals increases, user demands relating to functions, designs, etc. of the terminals are becoming more diversified, and manufacturers have been continuously researching and developing various kinds of portable wireless terminals in order to fulfill the present trends and user demands.

Conventional portable wireless terminals typically have an antenna device to provide good signal quality in relation to wireless communication with base stations.

FIG. 1 is a perspective view illustrating a conventional portable wireless terminal 100 having an integrated antenna device 119. Referring to FIG. 1, the portable wireless terminal 100 is a folder type terminal, and comprises a body 101, and a folder 102, which is hingedly coupled to the body 101. The folder 102 is adapted to be opened or closed as it hingedly rotates away from or toward the body 101. At an interior surface of the folder 102, facing the body 101, are arranged a main display unit 121 and a receiver module 123, and at an exterior surface of the folder 102 is arranged a sub-display unit 125. In addition, at an interior surface of the body 101, facing the folder 102, are arranged a keypad and a transmitter module, which are not shown in FIG. 1. According to the rotation of the folder 102, the keypad and transmitter module either are exposed to the outside or are concealed.

Meanwhile, the antenna device 119 extends upward from and outside of an upper end of the body 101. The antenna device 119 typically includes a helical antenna therein, and, according to the desired product, may include an additional retractable/extendable whip antenna.

Such a configuration of the portable wireless terminal will be easily understood by those skilled in the art.

However, when an antenna device protrudes outside of the portable wireless terminal, the possible types of portable wireless terminals are limited in the diversity of their designs, and there is a risk of damage to the antenna device from external shock. Furthermore, since the antenna device has to be assembled independent of an assembly process of other elements of the portable wireless terminal, problems exist such as reduced productivity.

### SUMMARY OF THE INVENTION

Therefore, the present invention has been made in view of the above problems, and it is an object of the present invention to provide an antenna device for portable wireless terminals, which is advantageous in diversification of designs of the portable wireless terminals, and has a reduced risk of damage due to external shock.

It is another object of the present invention to provide an antenna device for portable wireless terminals, which can be assembled along with other elements of the terminals in a single assembly process, resulting in an improvement in productivity of the terminals.

It is yet another object of the present invention to provide a dual-band antenna device operating in different frequency bands.

In accordance with an aspect of the present invention, the above and other objects can be accomplished by providing an antenna device for a portable wireless terminal including a pair of chip antennas mounted on a main board of the terminal and adapted to transmit and receive high-frequency signals of different frequency bands, respectively; at least one pair of radiation plates electrically connected with the respective chip antennas; and a high-frequency signal line for electrically connecting the chip antennas with a circuit portion of the main board.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating a conventional portable wireless terminal having an integrated antenna device;

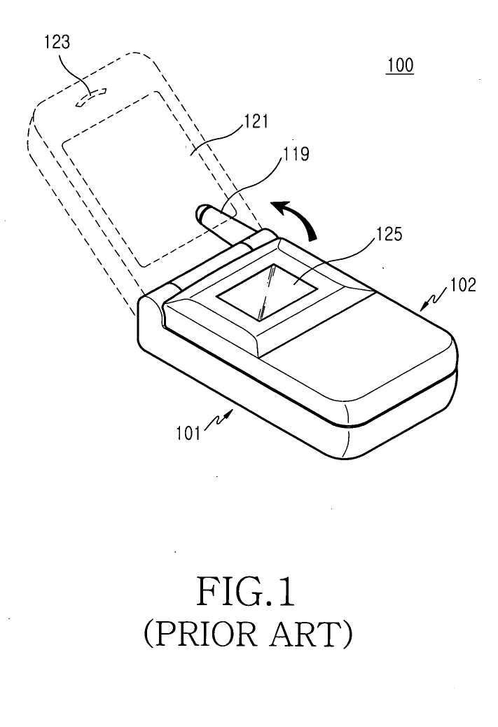

FIG. 2 is a perspective view illustrating a portable wireless terminal having an antenna device in accordance with a preferred embodiment of the present invention; and

FIG. 3 is an exploded perspective view illustrating the antenna device for the portable wireless terminal shown in FIG. 2.

### DETAILED DESCRIPTION OF THE PREFERRED EMBODIMENT

Now, a preferred embodiment of the present invention will be described in detail with reference to the annexed drawings. In the following description, a detailed description of known functions and configurations incorporated herein will be omitted to avoid making the subject matter of the present invention unclear.

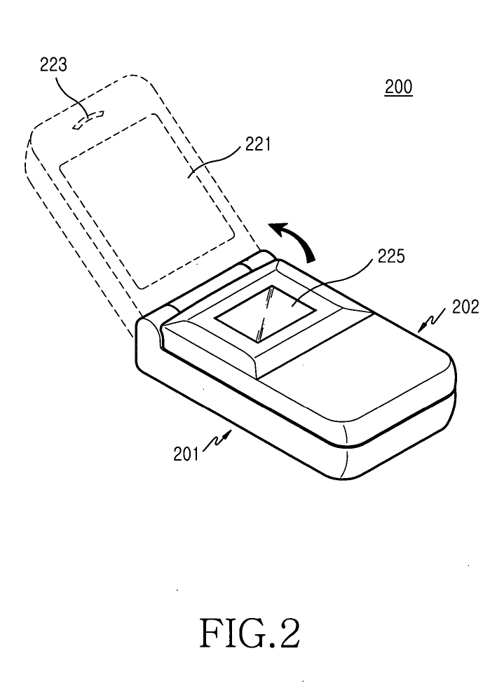

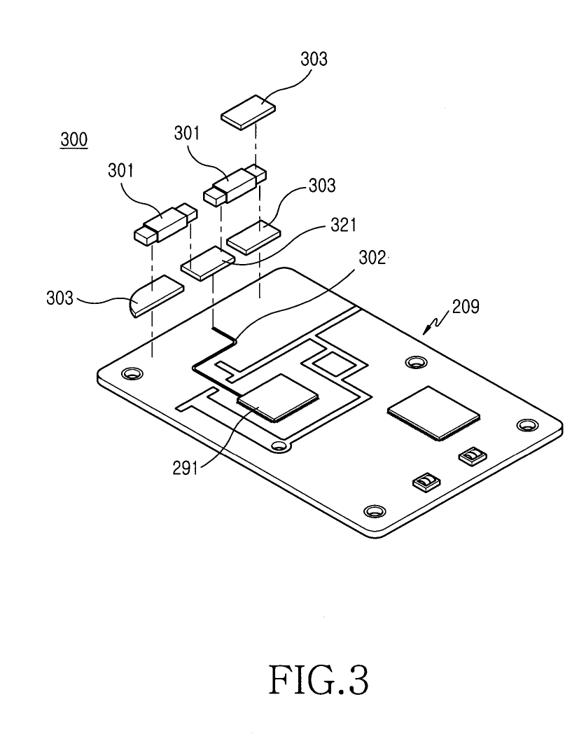

FIG. 2 is a perspective view illustrating a portable wireless terminal 200 having an antenna device 300 in accordance with a preferred embodiment of the present invention. FIG. 3 is an exploded perspective view illustrating the antenna device 300 for the portable wireless terminal 200 shown in FIG. 2. As shown in FIGS. 2 and 3, the portable wireless terminal 200 comprises a body 201, and a folder 202, which is hingedly coupled to the body 201. The folder 202 is adapted to be opened or closed as it hingedly rotates away from or towards the body 201. At an interior surface of the folder 202, facing the body 201, are arranged a main display unit 221 and a receiver module 223, and at an exterior surface of the folder 202 is arranged a sub-display unit 225. In addition, at an interior surface of the body 201, facing the folder 202, are arranged a keypad and a transmitter module, which are not shown in FIG. 2. According to the rotation of the folder 202, the keypad and transmitter module either are exposed to the outside or are concealed.

Referring to FIG. 3, the antenna device 300 is mounted on a main board 209 incorporated in the body 201. The antenna device 300 comprises a pair of chip antennas 301, which operate in different frequency bands, respectively. The antenna device 300 further comprises a high-frequency signal line 302, radiation plates 303, and a connector member 321.

The chip antennas 301 are fabricated by winding a coil around a rectangular-post shaped ceramic dielectric and then wrapping a protective tube around the coil. The chip antennas 301 are aligned along an upper end of the main board 209. A facing end of each chip antenna 301 is connected with the high-frequency signal line 302 via the connector member 321, and the other end of each chip antenna 301 is connected to a respective radiation plate 303.

The chip antennas 301 have different operating frequency bands depending on the number of windings of the coil. Accordingly, the two chip antennas 301 are operable in different frequency bands. Further, such chip antennas 301 are relatively easy to miniaturize, and thus can be easily mounted in a single wireless terminal. Therefore, by mounting a pair of such chip antennas operating in different frequency bands in a single wireless terminal, the terminal can be commonly used in the different frequency bands.

The high-frequency signal line 302 serves to electrically connect a circuit portion 291 of the main board 209 with the chip antennas 301, thereby enabling transmission and reception of high-frequency signals therebetween.

The radiation plates 303 not only increase radiation efficiency of the chip antennas 301, but also improve transmitting/receiving signal quality as they are used in the impedance matching of the antenna device 300. The radiation plates 303 are usually mounted below the chip antennas 301 so that they are interposed between the main board 209 and the respective chip antennas 301. Alternatively, according to the desired product, one or more additional radiation plates may be mounted above the chip antennas 301. Furthermore, although shown in FIG. 3 as the radiation plates 303 being mounted at positions adjacent to the chip antennas 301, respectively, one or more additional radiation plates may be mounted along a lower end of the main board 209. If the radiation plates 303 are mounted along the lower end of the main board 209, they are electrically connected with the chip antennas 301 via printed circuit patterns on the main board 209.

That is, the radiation plates 303 manufacturers can freely adjust the positions and connecting structures of the chip antennas 301 to conform to the desired radiation efficiency and impedance matching of the antenna device 300.

Various frequency bands are currently used by mobile communication companies. For example, in Korea, SK Telecom Co. uses a frequency band of approximately 800 MHz, and other PCS carriers, such as KTF (Korea Telecom Freetel) Co. and LG Telecom Co., use a frequency band of approximately 1.7 to 1.8 GHz. Therefore, when a user tries to change his/her mobile communication carrier from SK Telecom Co. to KTF Co. or LG Telecom CO. or vice versa, the user inevitably has to replace his/her terminal. This burdens the user with new terminal purchase costs, and also results in unnecessary disposal costs of existing terminals.

In addition, there exists a difference in frequency bands between a U.S. based mobile communication systems and European mobile communication systems. Therefore, manufacturers that try to export their products to numerous countries and to countries using more than one frequency band for their mobile communication systems will have to bear the cost increase associated with providing additional production facilities and providing mobile terminals operable in different frequency bands.

However, since the antenna device 300 according to the present invention can operate in different frequency bands, it is not necessary for users using portable wireless terminals containing the antenna device 300 to exchange or replace their terminals when changing mobile communication carriers. Further, it is not necessary for manufacturers supplying terminals to countries using different mobile communication frequency bands to bear the costs associated with providing additional production facilities.

In addition, since the antenna device 300 according to the present invention is mounted on the main board 209 inside the terminal and does not protrude outwardly from the terminal, this allows for a greater number of terminal designs and also prevents damage to the antenna device 300 due to external shock. In relation to the mounting of the antenna device on the main board of the terminal, the ability to use miniaturized chip antennas allows the chip antennas to be internally mounted while still affording sufficient space for mounting other elements of the terminal. Further, since the chip antennas can be mounted on the main board along with the other elements by using a single surface mounting device, they can be easily and automatically assembled, without manual operation. Therefore, the antenna device in accordance with the present invention is advantageous for factory automation and improves productivity.

As apparent from the above description, the present invention provides an antenna device that can relieve a limitation in the design of a portable wireless terminal by virtue of the fact that small chip antennas are mounted inside the terminal and advantageously improves productivity by allowing the chip antennas to be simply mounted on a main board using a surface mounting device. Furthermore, use of two chip antennas that respectively operate in different frequency bands allows the antenna device of the present invention to be used in different countries and to receive service from different mobile communication carriers that use different frequency bands, resulting in alleviation in cost burdens of manufacturers and users, as well as saving disposal costs of existing terminals.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. An antenna device for a portable wireless terminal comprising:
a pair of chip antennas mounted on a main board of the terminal and adapted to transmit and receive high-frequency signals of different frequency bands, respectively;
at least one pair of radiation plates electrically connected with the respective chip antennas; and
a high-frequency signal line for electrically connecting the pair of chip antennas with a circuit portion of the main board.

2. The device as set forth in claim 1, wherein the pair of the chip antennas are mounted close to each other along an upper end of the main board.

3. The device as set forth in claim 1, wherein the radiation plates are connected, respectively, to one end of the respective chip antennas, and are positioned between the chip antennas and the main board.

4. The device as set forth in claim 1, wherein the radiation plates are connected, respectively, to one end of the respective chip antennas, and are positioned above the chip antennas.

5. The device as set forth in claim 1, wherein the radiation plates are electrically connected with the chip antennas, respectively, and are mounted along a lower end of the main board.
